(19) United States
(12) Patent Application Publication
(10) Pub. No.: US 2011/0216438 A1
(43) Pub. Date: Sep. 8, 2011

(54) READER-WRITER OFFSET CORRECTION FOR A DISK DRIVE

(76) Inventor: Gabor SZITA, Newark, CA (US)

(21) Appl. No.: 12/719,772

(22) Filed: Mar. 8, 2010

(51) Int. Cl. G11B 21/02

(52) U.S. Cl. 360/75; G9B/21.003

(57) ABSTRACT

A servo wedge on a recording medium for a disk drive includes a gray-code field that stores a micro-jog correction factor for a data track. The micro-jog correction factor compensates for the effect of accumulated track pitch variations. In one embodiment, the radial wedge formed by gray-code fields for adjacent data tracks is a continuous radial wedge similar to the gray-code field used for encoding track numbers.

### BACKGROUND OF THE INVENTION

1. Field of the Invention

Embodiments of the present invention relate generally to disk drives and, more particularly, to systems and methods for reader-writer offset correction in such drives.

2. Description of the Related Art

A disk drive is a data storage device that stores digital data in concentric tracks on the surface of a data storage disk. The data storage disk is a rotatable hard disk with a layer of magnetic material thereon, and data is read from or written to a desired track on the data storage disk using a read/write head that is held proximate to the track while the disk spins about its center at a constant angular velocity. Typically there is a write head for writing data and a separate read head for reading data. The read and write heads are typically separated by some distance both in radial and tangential direction.

To properly align the read/write head with a desired track during a read or write operation, disk drives generally use a closed-loop servo system that relies on servo data stored in servo sectors written on the disk surface when the disk drive is manufactured. These servo sectors form “servo wedges” or “servo spokes” from the outer to inner diameter of the disk, and are either written on the disk surface by an external device, such as a servo track writer, or by the drive itself using a self servo-writing procedure. The read/write head can be positioned with respect to the data storage disk by using feedback control based on servo information read from the servo wedges with the read head. Thus, the read head, which collects the servo information from the servo wedges, is used to position the heads relative to the disk for both reading and writing operations.

Because the read and write heads are radially offset from each other with respect to the storage disk, the read head is generally positioned over a different track than the write head. This radial offset is referred to as “micro-jog,” and for disk drives employing a rotary actuator for moving the read/write head with respect to the disk, the magnitude of micro-jog varies across the surface of the disk. To read back data written by the write head, the read head must be accurately positioned over the center of the desired data track, which requires accurate knowledge of the micro-jog for that data track. Techniques are known for calculating micro-jog values, typically involving a micro-jog calibration that is performed at multiple locations across the disk surface during the post-manufacturing self-test process so that an interpolated curve can be constructed that defines the micro-jog for all data tracks on the disk.

Such calibration schemes assume that track pitch, i.e., the radial distance between data tracks, is substantially constant. In reality, variation in track pitch from the nominal track pitch for the disk is common, albeit relatively small, e.g., on the order of ±1% of total track pitch. This level of variation is generally small enough to avoid significant data integrity problems for an individual track. However, even such small variation in track pitch adversely affects the accuracy of micro-jog values produced by an interpolated curve, since the small variations in track pitch can accumulate over the span of the reader-writer offset to produce a relatively large position error of the read head. For example, assume that the reader-writer offset, i.e., the micro-jog, for a particular location on the disk spans 10 tracks. If the track pitch for each of the 10 tracks between the read head position and the write head position is only 1% narrower than the nominal track pitch, the resulting inaccuracy of the micro-jog value provided by an interpolated calibration curve is 10% of the spacing between tracks. The 1% variation from nominal track width accumulates over the 10 tracks because the interpolated curve that provides the value of micro-jog assumes that all tracks have nominal track pitch and ignores the small variations in track pitch that can occur across the disk surface. Consequently, when the read head is moved the micro-jog distance dictated by the interpolated calibration curve, the read head is positioned 10% off-track, a radial position error large enough to prevent the read head from successfully reading data.

In light of the above, there is a need in the art for a micro-jog correction method that compensates for variations in track spacing.

### SUMMARY OF THE INVENTION

One or more embodiments of the present invention provide a system and method for micro-jog correction in a disk drive that compensates for variations in track spacing. In the method, a micro-jog correction factor is determined for a data track of a disk drive and is encoded on the disk in “gray-code” format, an encoding of numbers in which two successive values differ in only one bit. The gray-code-formatted micro-jog correction factor is disposed in a position correction field of a servo wedge for the data track and is aligned with similar micro-jog position correction fields for adjacent data tracks to form a radial wedge. The use of gray-code format for micro-jog correction data allows recovery of the micro-jog correction data for any data track with an accuracy of ±one count. In one embodiment, the radial wedge formed by the micro-jog position correction fields is a continuous radial wedge similar to the gray-code field used for encoding track numbers, i.e., with substantially no gaps between data tracks.

A method of positioning a read head of a hard disk drive above a data track of a recordable medium, according to an embodiment of the invention, includes the steps of determining a target position above the recordable medium, and moving the read head toward the target position and, during movement, reading one or more correction factors encoded in gray-code format and adjusting the target position based on the correction factors.

A disk drive assembly comprising according to an embodiment of the invention includes a read head, a drive unit for moving the read head to a radial position above a recording medium, and a control unit for controlling the movement of the read head by issuing drive signals to the drive unit, wherein the control unit is programmed to determine a target position above the recording medium and issue a drive signal to the drive unit to move the read head toward the target position and, during movement, read one or more correction factors encoded in gray-code format and adjust the target position based on the correction factors.

A recording medium for a disk drive assembly, according to an embodiment of the invention, comprises a plurality of servo wedges, wherein each of the servo wedges has reader-writer offset correction factors written therein in gray-code format.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a perspective view of a disk drive that can benefit from embodiments of the invention as described herein.

FIG. 2 illustrates a storage disk with data organized in a typical manner known in the art.

FIG. 3 is a graph demonstrating how track pitch for concentric data storage tracks may vary with respect to the nominal track pitch for a disk drive.

FIG. 4 is a partial schematic diagram of a storage disk illustrating the trajectory of a read and write heads.

FIGS. 5A-5C are partial schematic diagrams of a storage disk and read and write heads during disk drive read and write operations, according to embodiments of the invention.

FIGS. 6A-6B are schematic diagrams of magnetic indicia written on two adjacent data storage tracks on a disk drive.

FIG. 7 is a partial schematic diagram of a servo wedge on a storage disk that includes a micro-jog correction factor field, according to one or more embodiments of the invention.

FIG. 8 is a flow chart that summarizes, in a stepwise fashion, a method for micro-jog correction in a disk drive that compensates for variations in track spacing, according to an embodiment of the invention.

For clarity, identical reference numbers have been used, where applicable, to designate identical elements that are common between figures. It is contemplated that features of one embodiment may be incorporated in other embodiments without further recitation.

### DETAILED DESCRIPTION

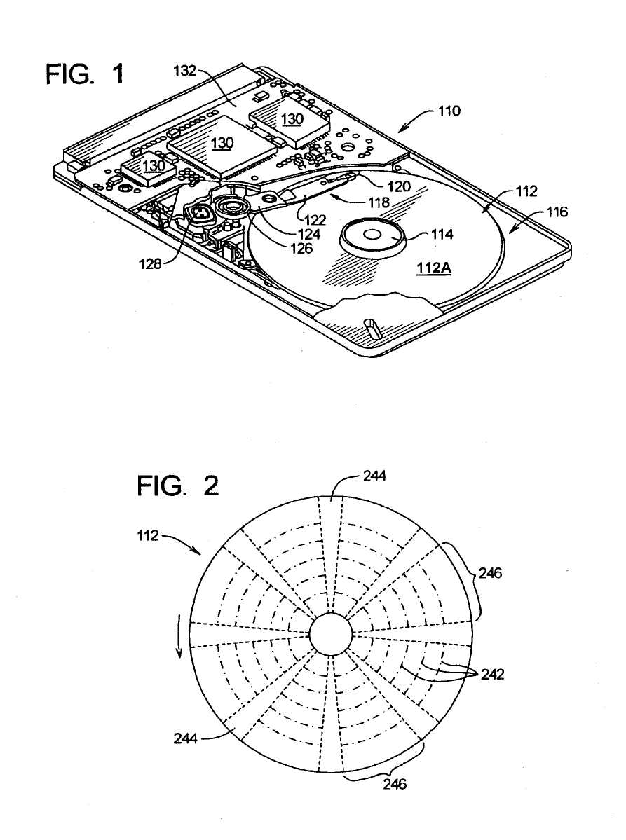

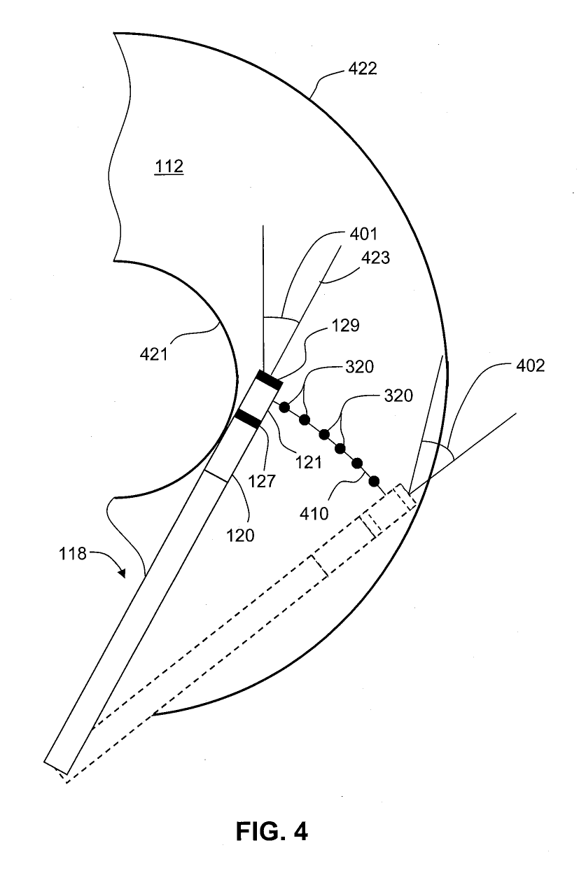

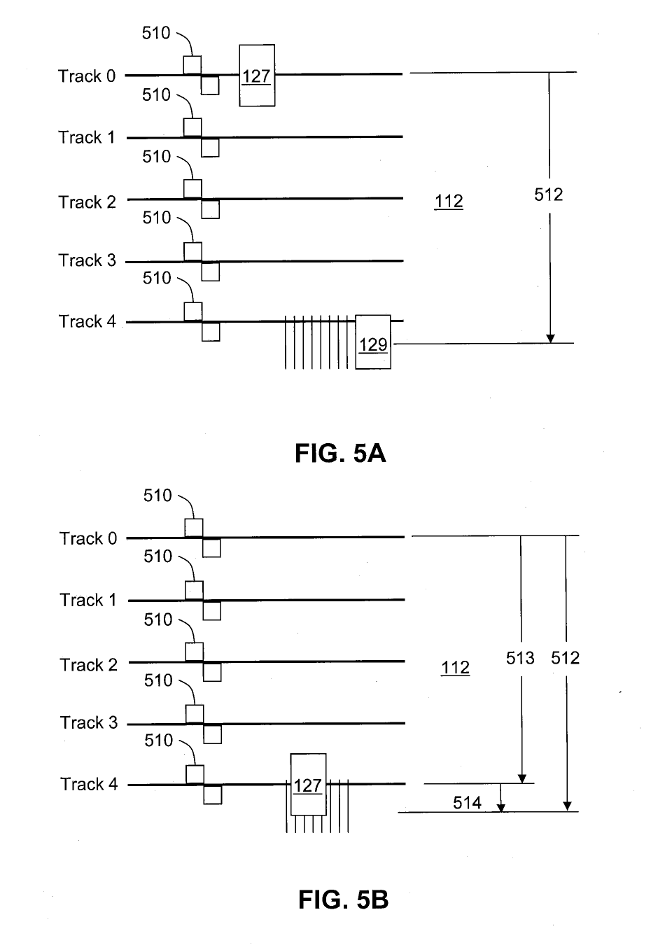

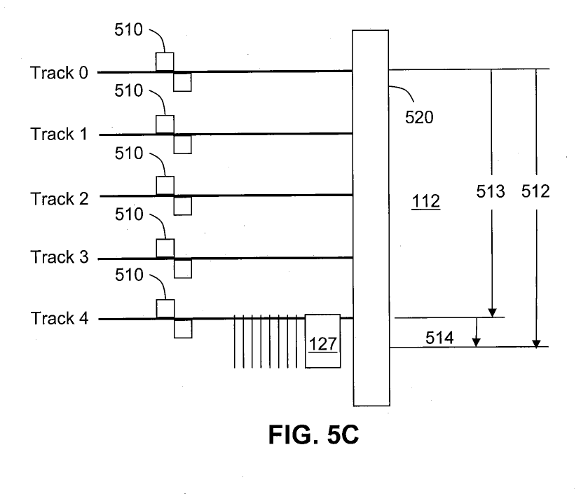

FIG. 1 is a perspective view of a disk drive 110 that can benefit from embodiments of the invention as described herein. For clarity, disk drive 110 is illustrated without a top cover. Disk drive 110 includes a storage disk 112 that is rotated by a spindle motor 114. Spindle motor 114 is mounted on a base plate 116. An actuator arm assembly 118 is also mounted on base plate 116, and has a slider 120 mounted on a flexure arm 122 with a read head 127 and a write head 129. For clarity, read head 127 and write head 129 are omitted from FIG. 1, and are instead shown in FIGS. 4 and 5A-5C. Flexure arm 122 is attached to an actuator arm 124 that rotates about a bearing assembly 126. Voice coil motor 128 moves slider 120 relative to storage disk 112, thereby positioning read and write heads 127 and 129 over the desired concentric data storage track disposed on the surface 112A of storage disk 112. Spindle motor 114, read and write heads 127 and 129, and voice coil motor 128 are coupled to electronic circuits 130, which are mounted on a printed circuit board 132. The electronic circuits 130 include a read channel, a microprocessor-based controller, and random access memory (RAM). For clarity of description, disk drive 110 is illustrated with a single storage disk 112 and actuator arm assembly 118. Disk drive 110, however, may also include multiple storage disks 112 and multiple actuator arm assemblies 118. In addition, each side of disk 112 may have an associated read and write heads 127 and 129, both of which are collectively coupled to the rotary actuator 130 such that both read and write heads 127 and 129 pivot in unison. The invention described herein is equally applicable to devices wherein the individual heads are configured to move separately some small distance relative to the actuator using dual-stage actuation.

FIG. 2 illustrates storage disk 112 with data organized in a typical manner after servo wedges 244 have been written on storage disk 112 by either a media writer or by disk drive 110 itself via self servo-write (SSW). Storage disk 112 includes concentric data storage tracks 242 located in data sectors 246 for storing data. Concentric data storage tracks 242 are positionally defined by servo information written in servo wedges 244. Each of concentric data storage tracks 242 is schematically illustrated as a centerline, but in practice occupies a finite width about a corresponding centerline. Substantially radially aligned servo wedges 244 are shown crossing concentric data storage tracks 242 and have servo sectors containing servo information that defines the radial position and track pitch, i.e., spacing, of concentric data storage tracks 242. Such servo information includes a reference signal that is read by read head 127 during read and write operations to position the read and write 127 and 129 above a desired track 242. Servo wedges 244 are described in greater detail in conjunction with FIG. 7, below. In practice servo wedges 244 may be somewhat curved, for example, configured in a shallow spiral pattern. Typically, the actual number of concentric data storage tracks 242 and servo wedges 244 included on storage disk 112 is considerably larger than illustrated in FIG. 2. For example, storage disk 112 may include hundreds of thousands of concentric data storage tracks 242 and hundreds of servo wedges 244.

As noted above, servo wedges 244 are written on storage disk 112 by either a media writer or by disk drive 110 itself via an SSW process. In either case, due to fluctuations in writing head position that occur during the process of writing servo wedges 244, the majority of concentric data storage tracks 242 vary slightly from the nominal track pitch for disk drive 110, i.e., most of concentric data storage tracks 242 are either wider or narrower than the nominal track pitch. In addition, because writing head fluctuations are generally low frequency fluctuations in the 10-100 Hz range, track pitch for concentric data storage tracks 242 does not vary randomly from track to track. Instead, track pitch varies in a somewhat periodic fashion, with alternating groupings of narrower and then wider tracks.

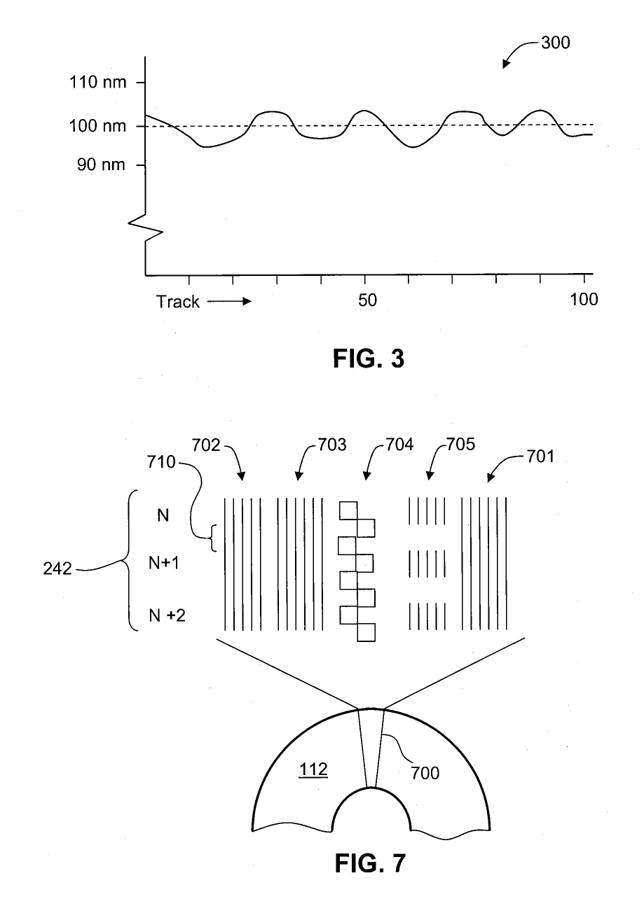

By way of illustration, FIG. 3 is a graph 300 demonstrating how track pitch for concentric data storage tracks 242 may vary with respect to the nominal track pitch for disk drive 110. In graph 300, the abscissa represents track number and the ordinate represents actual track pitch of an exemplary storage disk. As shown, the actual track pitch of tracks 1-100 varies from 4 or 5 nm greater than to 4 or 5 nm less than the ideal track pitch of 100 nm in a somewhat periodic and gradual fashion. Blocks of ten or more adjacent tracks having wider than nominal track pitch generally alternate with blocks of ten or more adjacent tracks having narrower than nominal track pitch, so that over a large number of tracks, e.g., 20 or more, the average track pitch is substantially equal to the nominal track pitch.

When disk drive 110 is in operation, actuator arm assembly 118 sweeps an arc between an inner diameter (ID) and an outer diameter (OD) of storage disk 112. Actuator arm assembly 118 accelerates in one angular direction when current is passed through the voice coil of voice coil motor 128 and accelerates in an opposite direction when the current is reversed, allowing for control of the position of actuator arm assembly 118 and the attached read and write heads 127 and 129 with respect to storage disk 112. Voice coil motor 128 is coupled with a servo system known in the art that uses positioning data read from storage disk 112 by read head 127 to determine the position of read and write heads 127 and 129 over concentric tracks 242. The servo system determines an appropriate current to drive through the voice coil of voice coil motor 128, and drives said current using a current driver and associated circuitry. As is known in the art, as actuator arm assembly 118 sweeps an arc between the ID and the OD of storage disk 112, the skew angle between slider 120 and storage disk 112 varies, where skew angle is defined as the angle between the longitudinal axis of slider 120 and the direction of tangential velocity of storage disk 112.

FIG. 4 is a partial schematic diagram of storage disk 112 illustrating the trajectory 410 of read and write heads 127 and 129 as actuator arm assembly 118 moves between ID 421 and OD 422 of storage disk 112. When actuator arm assembly 118 positions read and write heads 127 and 129 at ID 421, a first skew angle 401 is formed between the longitudinal axis 423 of slider 120 and the direction of tangential velocity of storage disk 112 at the point on storage disk 112 directly adjacent to read and write heads 127 and 129. Similarly, when actuator arm assembly 118 positions read and write heads 127 and 129 at OD 422, a second skew angle 402 is formed that is greater than first skew angle 401. Thus, as read and write heads 127 and 129 move along trajectory 410, the skew angle between read and write heads 127 and 129 varies. As the skew angle varies, the radial offset with respect to storage disk 112 between read and write heads 127 and 129, i.e., the micro-jog, also varies.

During post manufacturing self-test process, the micro-jog is measured for each of the concentric tracks 242. Then, for each of a plurality of zones 320 along trajectory 410, the micro-jog is averaged. Using the average micro-jog values, each of which represents one of the zones 320, curve fitting and interpolation techniques known in the art are used to produce a calibration curve that provides an estimated micro-jog value for any concentric track 242. A representation of this calibration curve is stored in tables in memory for use by the servo system. Also, during post manufacturing self-test process, micro-jog correction factors for concentric tracks 242 are written onto the corresponding data tracks of storage disk 112. A micro-jog correction factor represents the difference in the actual micro-jog value as measured and the micro-jog value as estimated from the calibration curve.

FIGS. 5A-5C are partial schematic diagrams of storage disk 112 and read and write heads 127 and 129 during read and write operations of disk drive 110, according to embodiments of the invention. In FIGS. 5A-5C, the track positions of a number of concentric tracks as defined by servo bursts 510, i.e., Tracks 0-4, are illustrated. Due to the variations in track pitch described above in conjunction with FIG. 3, the actual track pitch of Tracks 0-4 may be slightly smaller or larger than the nominal track pitch for storage disk 112, for example on the order of 1 or 2 nm.

In FIG. 5A, write head 129 performs a write operation with the read head 127 positioned above Track 0. During this write operation, read head 127 reads position information from Track 0 so that the servo loop of disk drive 110 holds read head 127 and write head 129 in the desired position relative to storage disk 112. As shown, read head 127 and write head 129 are separated by a distance 512. Because of this separation, read head 127 has to move by distance 512 to read the data that has been written by write head 129 while read head 127 was positioned above Track 0.

Distance 512 is the actual micro-jog corresponding to Track 0. An estimate of this micro-jog is obtained from the calibration curve described above in conjunction with FIG. 4. This estimate is represented in FIG. 5B as 513 and is an example of a micro-jog value of 4 tracks. However, at this position, read head 127 may not be able to read the data written on a data track corresponding to Track 0. A correction by distance 514 is needed to properly read the data written on a data track corresponding to Track 0.

In the embodiments according to the invention, a gray-code field 520 containing micro-jog correction factors is used. As read head 127 moves from Track 0 to an estimated target track position, it reads micro-jog correction factors contained in gray-code field 520 and continuously reads and applies the micro-jog correction factors as it moves towards the estimated target track position. The final, converged position of read head 127 is shown in FIG. 5C.

Table 1 provides a series of 4-bit gray-codes that may be used in embodiments of the invention to store micro-jog correction factors, where the gray-codes are written on data tracks of storage disk 112. The first column of Table 1 presents the number of counts for the adjustment. In such an embodiment, one “count” is scaled to be equal to the maximum value by which track pitch can vary between two adjacent data tracks of a disk drive, e.g., 1 nm, 2 nm, etc. The second column presents the corresponding gray-code binary bit sequences, or gray-code “words,” that may be written on a data track in the form of magnetic indicia. Inspection of Table 1 reveals that for each step count in the first column, there is a unique gray-code word in the second column. In addition, it should be noted that any two adjacent gray-code words change only one bit at a time, i.e., adjacent words in Table 1 are identical except for one bit position change. By using gray-codes rather than conventional binary bit sequences, the micro-jog correction factor for any particular data track can be read by a read head with an accuracy of ±1 count, even if the read head is positioned substantially between that particular data track and an adjacent data track.

TABLE 1
Example Gray-codes

| Number of | Gray-code |
|---|---|
| Counts | Word |
| 0 | 0000 |
| 1 | 0001 |
| 2 | 0011 |
| 3 | 0010 |
| 4 | 0110 |
| 5 | 0100 |
| 6 | 0101 |
| 7 | 0111 |
| 8 | 1111 |
| 9 | 1110 |
| 10 | 1100 |
| 11 | 1101 |
| 12 | 1001 |
| 13 | 1011 |
| 14 | 1010 |
| 15 | 1000 |

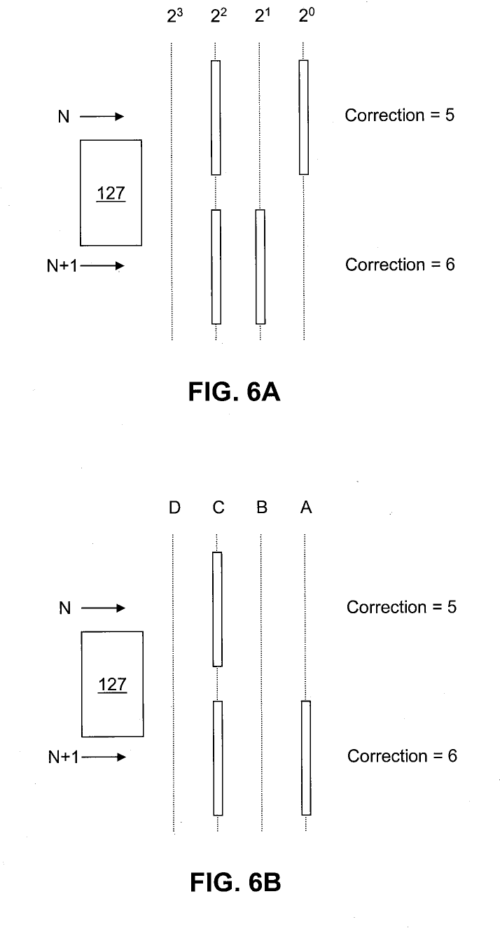

FIG. 6A is a schematic diagram of magnetic indicia written on two adjacent data storage tracks on a disk drive, where the indicia are written in conventional binary code format and the value of the binary word in each data track represents a micro-jog correction factor. In this example, the binary code is a 4-bit word, where the first column indicates a value of 2³, the second column indicates a value of 2², the third column indicates a value of 2¹, and the fourth column indicates a value of 2°. The presence of a bar represents a “1” value for a particular column and the absence of a bar represents a “0” value for the column. As shown, data track N has a binary word (0-1-0-1) representing a value of 5 stored therein and adjacent data track N+1 has a binary word (0-1-1-0) representing a value of 6 stored therein. If read head 127 is attempting to read data track N, but is initially positioned substantially between data tracks N and N+1, the value that read head 127 will read is unpredictable. Namely, read head 127 may only read the magnetic indicia of data track N (0-1-0-1), which indicates a correction of 5 counts. Alternatively, read head 127 may only read the magnetic indicia of data track N+1 (0-1-1-0), which indicates a correction of 6 counts. Furthermore, read head 127 may read a combination of both data tracks (0-1-1-1) or (0-1-0-0), which indicate corrections of 7 counts and 4 counts, respectively. Thus, the use of binary code format to store a micro-jog correction factor is of little value unless reader 127 can be aligned accurately with the desired data track, in which case the micro-jog correction factor is not really needed.

FIG. 6B is a schematic diagram of magnetic indicia written on two adjacent data storage tracks on a disk drive, where the indicia are written in gray-code format and the value of the gray-code word in each data track represents a micro-jog correction factor. In this example, the gray-code is a 4-bit word from Table 1 that corresponds to a unique value from 0-15 and, unlike binary code, is not a sum of the columns. As shown, data track N has a gray-code word representing a value of 5 stored therein and adjacent data track N+1 has a gray-code word representing a value of 6 stored therein. If read head 127 is attempting to read data track N, but is initially positioned substantially between data tracks N and N+1, the value that read head 127 reads is either 5 or 6. This is because any two adjacent gray-code words change by one bit and because the micro-jog correction factor represented by the gray-code words is scaled so that the maximum amount the micro-jog correction factor can change between adjacent data tracks is one count. Whether read head 127 reads the magnetic indicia of data track N, of data track N+1, or a combination of both, the only possible values to be read are 5 or 6. Thus, the use of gray-codes to store micro-jog correction factor on a disk, such as track pitch variation micro-jog, allow the retrieval of the micro-jog correction factors regardless of the accuracy of the positioning of read head 127.

FIG. 7 is a partial schematic diagram of a servo wedge 700 on storage disk 112 that includes a micro-jog correction factor field 701, according to one or more embodiments of the invention. Servo wedge 700 includes servo information for each of concentric tracks 242 on storage disk 112. A portion of servo wedge 700 is illustrated that includes servo information for three of concentric data storage tracks 242, specifically Track N, Track N+1, and Track N+2. Servo wedge 700 is substantially similar to servo wedges 244, described above in conjunction with FIG. 2, and includes a preamble field 702, a track identification field 703, a servo burst field 704, a repeatable run-out (RRO) field 705, and micro-jog correction factor field 701. Preamble field 702, track identification field 703, servo burst field 704, and repeatable run-out (RRO) field 705 are features commonly employed in servo wedges of disk drives and are known in the art. Micro-jog correction factor field 701 according to embodiments of the invention includes a gray-code word having a value that indicates how many “counts” a micro-jog value should be modified to compensate for accumulated track pitch variation for the given data track.

In one embodiment, micro-jog correction factor field 701 is written with substantially no gap between data tracks. In such an embodiment, the lack of gap 710 maximizes the amplitude of a signal read from micro-jog correction factor field 701 by read head 127 when read head 127 is positioned between data storage tracks.

In another embodiment, the micro-jog correction factor field 701 employs an extra bit to indicate whether the correction factor is a positive or negative value. Alternatively, the calibration curve described in conjunction with FIG. 4 is adjusted so that only positive correction factors are used.

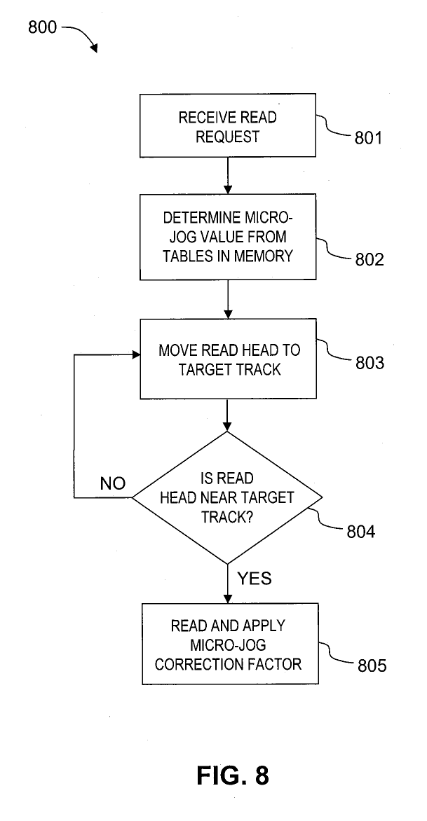

FIG. 8 is a flow chart that summarizes, in a stepwise fashion, a method 800 for micro-jog correction in a disk drive, according to an embodiment of the invention. Method 800 is described in terms of a disk drive substantially similar to disk drive 110 in FIG. 1. However, other disk drives may also benefit from the use of method 800. The commands for carrying out steps 801-805 may reside in the disk drive control algorithm and/or as values stored in the electronic circuits of the disk drive or on the storage disk itself. As described above in conjunction with FIG. 4, prior to the first step of method 800, a micro-jog calibration curve is constructed and tables of values representing the micro-jog calibration curve are stored in memory.

In step 801, a request to read from a particular track is received. In step 802, micro-jog value corresponding to this particular track is determined from tables in memory. In step 803, read head 127 is moved toward a target track based on the micro-jog value. If according to step 804, read head 127 is near the target track, e.g., 5 or so tracks away, micro-jog correction factor is continuously read and applied. In this method, convergence occurs substantially above the desired data track and data is read from the desired data track.

While the foregoing is directed to embodiments of the present invention, other and further embodiments of the invention may be devised without departing from the basic scope thereof, and the scope thereof is determined by the claims that follow.

I claim:

1. A method of positioning a read head of a hard disk drive above a data track of a recordable medium, comprising the steps of:
determining a target position above the recordable medium; and
moving the read head toward the target position and, during movement, reading one or more correction factors encoded in gray-code format and adjusting the target position based on the correction factors.

2. The method according to claim 1, wherein the one or more correction factors are not read until the read head is within a predetermined number of tracks from the target position.

3. The method according to claim 1, wherein the target position is initially determined based on tabulated values.

4. The method according to claim 1, wherein the recordable medium has correction factors written thereon and adjacent correction factors differ by a value of no more than one.

5. The method according to claim 1, wherein the recording medium has a plurality of servo wedges and the correction factors are written in the servo wedge locations.

6. The method according to claim 1, wherein, during movement, the target position is adjusted continuously based on the correction factors.

7. The method according to claim 1, wherein the correction factors are written with substantially no gap between adjacent correction factors.

8. A disk drive assembly comprising:
a read head;
a drive unit for moving the read head to a radial position above a recording medium; and
a control unit for controlling the movement of the read head by issuing drive signals to the drive unit,
wherein the control unit is programmed to determine a target position above the recording medium and issue a drive signal to the drive unit to move the read head toward the target position and, during movement, read one or more correction factors encoded in gray-code format and adjust the target position based on the correction factors.

9. The disk drive assembly according to claim 8, further comprising a memory unit storing values based on which the control unit determines the target position.

10. The disk drive assembly according to claim 8, wherein the recordable medium has correction factors written thereon and adjacent correction factors differ by a value of no more than one.

11. The disk drive assembly according to claim 10, wherein the recording medium has a plurality of servo wedges and correction factors encoded in gray-code format are written as a component of the servo wedges.

12. The disk drive assembly according to claim 11, wherein the correction factors encoded in gray-code format are written in each of the servo wedges so that they are substantially continuous from an inner diameter of the recording medium to an outer diameter of the recording medium.

13. The disk drive assembly according to claim 12, wherein each servo wedge has an additional field of values representing track numbers written in gray-code format.

14. A recording medium for a disk drive assembly comprising a plurality of servo wedges, wherein each of the servo wedges has reader-writer offset correction factors written therein in gray-code format.

15. The recording medium according to claim 14, wherein the correction factors are written in each of the servo wedges so that they are substantially continuous from an inner diameter of the recording medium to an outer diameter of the recording medium.

16. The recording medium according to claim 15, wherein each servo wedge has an additional field of values written in gray-code format.

17. The recording medium according to claim 14, wherein adjacent correction factors differ by a value of no more than one.

18. The recording medium according to claim 14, further comprising data tracks that are not in alignment with servo bursts.

19. The recording medium according to claim 18, wherein the correction factors are written in substantial alignment with the data tracks.
